(19) United States
(12) Patent Application Publication
(10) Pub. No.: US 2008/0141760 A1
(43) Pub. Date: Jun. 19, 2008

(54) LEAK DETECTION IN A FUEL CELL SYSTEM

(75) Inventors: Jon R. Sienkowski, Rochester, NY (US); David A. Arthur, Honeoye Falls, NY (US); Abdullah B. Alp, West Henrietta, NY (US); Prasad Gade, Webster, NY (US); Thomas Weispfenning, Ober-Ramstadt (DE); Peter Willimowski, Rossdorf (DE); Jurgen Thyroff, Harxheim (DE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/612,525

(22) Filed: Dec. 19, 2006

(51) Int. Cl. G01M 3/26

(52) U.S. Cl. 73/40.5 R

(57) ABSTRACT

A diagnostic method of detecting component failures in a fuel cell anode subsystem involves estimating fuel flow through injectors and comparing the estimated flow with a model based upon the system parameters. An observer based model is used to determine a residual value, the difference between the hydrogen input and the hydrogen consumed, and the residual is compared with a threshold range. In alternative embodiments, the stack current and the state of the valves are used to calculate the required hydrogen flow through the injectors and the duty cycle of an injector is compared to a tolerance range.

### FIELD OF THE INVENTION

This invention relates to a method of detecting hydrogen leaks in the anode of a fuel cell system.

### BACKGROUND OF THE INVENTION

Electrochemical fuel cells convert fuel and an oxidant into electricity, a reaction product (such as water in the case of a hydrogen fueled and oxygen oxidizing fuel cell) and heat. In a hydrogen fueled and oxygen oxidizing fuel cell, the hydrogen enters the anode and the oxygen enters the cathode.

In the case of fuel cells for portable applications where air is available, such as automobiles, it can be easier to provide the oxygen for the reaction by using this air. This eliminates the need to carry oxygen in addition to hydrogen or some source of hydrogen. But there is a cost for using air instead of pure oxygen. Air contains many gasses other than oxygen. Nitrogen is the most common gas in the atmosphere comprising approximately three-fourths of air. Some nitrogen will eventually find its way from the cathode to the anode where it can buildup causing problems if it is not removed. It is generally removed by use of a bleed valve to allow the nitrogen to escape. Unfortunately some hydrogen can escape as well. Because releasing hydrogen can be very dangerous, it is important to make sure only a small amount of hydrogen has escaped and that hydrogen is not continuing to leak out of the anode when the bleed valve should be closed. Unfortunately, sensors to detect hydrogen in the fuel cell exhaust are very expensive increasing the cost of fuel cell deployment.

### SUMMARY OF THE INVENTION

The present invention uses a model based approach to detect when hydrogen is leaking from the anode. This approach involves establishing model based performance of a fuel cell and comparing to actual performance. When the model shows that less fuel should have been consumed than actually was, the presence of a leak is indicated.

Taking advantage of common sensors to monitor anode pressure, anode temperature, and fuel cell current production which should measure hydrogen consumed and with a way to determine hydrogen flow into the anode, it is possible to determine if there is a hydrogen leak. This is possible because a model can determine the amount hydrogen in the anode when given the pressure in an anode, the anode temperature, the amount of hydrogen being added to the anode, and the current production of the fuel cell (which can show the amount of hydrogen being consumed by the power cell). The results can then be compared to what happened over time to determine if there is a leak.

The fuel cell's fuel consumption can also be compared to the fuel cell's power output. Because the power output for a given amount of input fuel is known, when the power output drops relative to the fuel input it shows the presence of a leak. Additionally, the presence of gross voltage degradation over time can be shown. However, some adjustment for voltage degradation and stack to stack variation may be necessary. Finally, stack current can also be used as a leak indicator.

In one embodiment, the method of detecting fuel leaks in an anode subsystem of a fuel cell comprises the steps of measuring an anode pressure related to fuel flow through at least one injector; calculating an anode pressure related to fuel flow through the at least one injector; determining a difference between the measured anode pressure and the calculated anode pressure and comparing the difference with a threshold value; and indicating a fuel leak when the difference exceeds the threshold value.

In another embodiment, the method of detecting fuel leaks in an anode subsystem of a fuel cell comprises the steps of calculating a required fuel flow through at least one injector based upon a stack current generated by the fuel call and a state of valves in the anode subsystem; generating a tolerance band; comparing the calculated required fuel flow with the tolerance band; and indicating a component failure when the calculated required fuel flow is above or below the tolerance band.

In another embodiment, the method of detecting fuel leaks in an anode subsystem of a fuel cell comprises the steps of calculating a value representing fuel flow through at least one injector in the anode subsystem; generating a tolerance band; comparing the calculated value with the tolerance band; and indicating a component failure when the calculated value is above or below the tolerance band.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic diagram of a fuel cell stack anode;

FIG. 2 is a schematic diagram of the calculated model and the observer model for the anode shown in FIG. 1;

FIG. 3 is a graph of the “residual” of FIG. 2, the difference between the actual and expected anode pressure of a fuel cell in the case of an opened valve; and

FIG. 4 is a graph of the valve position of the anode drain valve relative to the hydrogen injector duty cycle including a moving average of the injector duty cycle which correlates to the hydrogen inlet flowrate.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

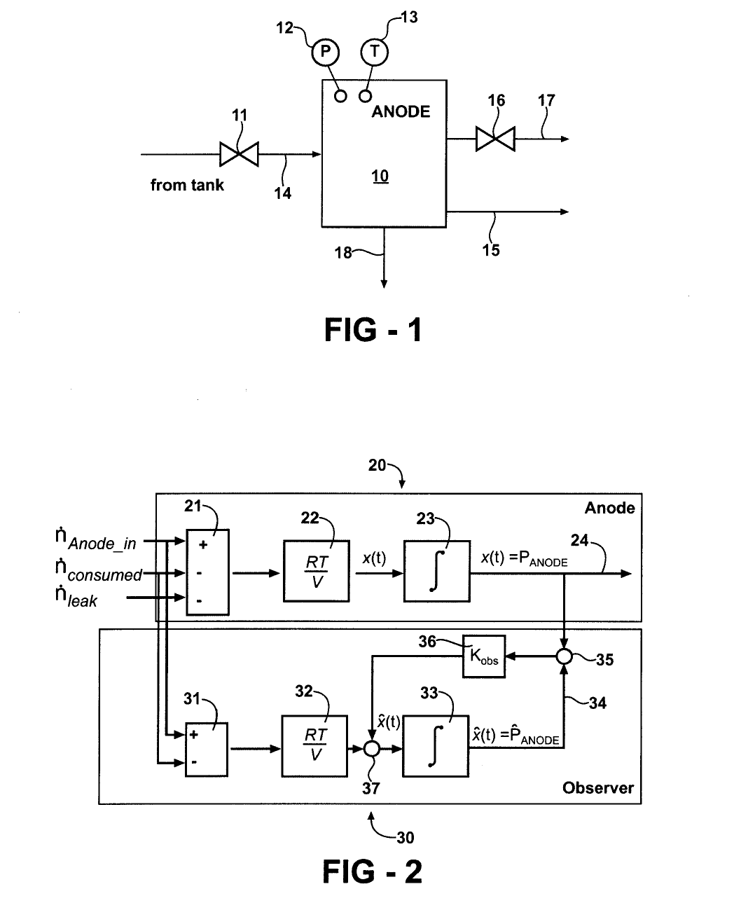

FIG. 1 is a schematic representation of a fuel cell anode 10 with an input and outputs. An input 14 is connected to a source (tank) of hydrogen through an input valve or injector 11. The outputs include an anode pressure signal 12 and an anode temperature signal 13. The rate of hydrogen moles converted in the fuel cell stack (output 18) is proportional to the stack current. Under stable conditions, the conversion rate is equal to the input rate plus a small amount of hydrogen crossover to the cathode. During stack operation, nitrogen accumulates in the anode 10 and a bleed valve 16 is used for removing the nitrogen at an output 17. When opening the valve 16, a small amount of H₂ is bled out of the anode 10. In addition, another valve (discharge valve not shown) might be connected to the anode 10 for pressure release in case of emergency and to open the anode during shutdown/startup. A possible hydrogen leak is represented as an output 15. A release of hydrogen to the atmosphere is undesirable, and thus attempts are made to avoid such a release. Causes of the release of hydrogen may be: a failure in bleed discharge valves; controls problem of discharge valves; too high membrane leakage; overboard leakage such as through a cracked plate; or failure of any other anode hardware including hoses or other anode valves besides the bleed valves.

The current state of the art is a hydrogen detection system in the car that uses hydrogen sensors. To detect hydrogen in the cathode exhaust at least one sensor has to be placed near the cathode exhaust outlet. Measurement in the cathode exhaust directly requires special equipment due to the high humidity and water droplets in that area. The main disadvantages of the hydrogen sensors are the high costs, the relatively late detection of excess hydrogen, and the inability to detect leaks that are not in the path where the hydrogen sensor is located, such as the vehicle tailpipe. In addition, a measurement near the outlet can not detect all critical situations due to the turbulence at the rear end of a driving car. Since a hydrogen measurement in the cathode exhaust is currently very difficult and costly due to the required sensor technology, measures to detect unwanted hydrogen releases from the anode are needed.

The present invention uses a model based approach to detect when hydrogen is leaking. Taking advantage of common sensors to monitor anode pressure, anode temperature and fuel cell current production, allows a measurement of hydrogen consumed. With a way to determine hydrogen inflow, such as by having a model for a fuel inlet that can determine the hydrogen inflow or, if injectors are used, the injectors determine exactly how much hydrogen is put into the anode. Once the variables are known, it is possible to determine if there is a hydrogen leak. This is possible because a model can determine if the amount of hydrogen that entered the anode and is no longer in the anode was an appropriate amount to produce the current or not. This can be determined based on the anode pressure given the temperature, fuel added and current production if there was no leak and the results can be compared to what actually happened over time to show the presence of a leak. If the quantity of fuel in the anode is held relatively constant, a leak is indicated simply by comparing the ratio of the quantity of fuel added to the anode and the current produced to the ratio that would be expected given the operating conditions.

Predicting the anode pressure is made possible by the application of the equation for an ideal gas “p×V=n×R×T” with:

p=Pressure [Pa]

V=Volume [m̂3]

n=number of moles of the gas

R=constant (8.31 J/(mol×K))

T=Temperature [K]

Therefore the formula for pressure can be written as p=n×R×T/V and specifically for the anode 10 shown in FIG. 1:

$${p}_{Anode} = \int \frac{RT ( {\dot{n}}_{Anode\_in} - {\dot{n}}_{consumed} )}{V} d t$$

with:

\dot{n}_{Anode}_{_{—}}ᵢₙ=rate of moles going into (input) the anode

\dot{n}_{consumed}=rate of moles consumed in the stack

As mentioned above, the equation for pressure holds for fault-free conditions. To estimate the leakage rate, a third variable is introduced to form the equation:

$${p}_{Anode} = \int \frac{RT ( {\dot{n}}_{Anode\_in} - {\dot{n}}_{consumed} - {\dot{n}}_{leak} )}{V} d t$$

The above equation can be solved for the leakage rate since the constant “R” and the volume are known for a given system, and the anode pressure and the temperature are directly measured by sensors, and the input rate and the consumed rate have to be calculated from other variables. For the calculation of the input rate, a model of the input valve or injector 11 is used. The consumed rate can be calculated from the current generated from the fuel cell. Thus, it should be possible to calculate the number of moles of gas present at any time. While the number of moles present will vary based on the hydrogen added to the anode and the hydrogen consumed by the fuel cell, both the moles added and consumed should be known. If the number of moles still in the anode is less than expected it shows the presence of a leak.

The problem with directly calculating the number of moles present is that small errors in the measurement of each different factor needed for the calculation can lead to a very inexact answer. For instance just considering the ideal gas law if the pressure and volume measurements were each 1% low, and the temperature measurement was 1% high then the calculation for the number of moles present would be 3% too low possibly falsely suggesting a leak. Thus, due to the amplification of noise, the above equation should not be differentiated to calculate the leak rate directly. In controls theory, it is shown that an observer based structure is preferable.

The problem of error with direct calculations is overcome by using the observer based structure shown in FIG. 2. The measured output value is generated by the anode system represented by the schematic calculated model 20. The input rate, the consumed rate and the leak rate are inputs to a summing block 21. An output from the block 21 is an input to a multiplication block 22 representing the constant “R” times the temperature divided by the volume. An output from the block 22 is an input to an integration block 23. An output 24 from the block 23 is the measured output value representing the anode pressure.

An observer structure 30 includes a summing block 31 for the input rate and the consumed rate. An output of the block 31 is an input to a multiplication block 32 representing the constant “R” times the temperature divided by the volume. An output from the block 32 is an input to an integration block 33. An output 34 from the block 33 is the calculated anode pressure. The output values 24 and 34 are combined at a summing point 35 that generates a difference to a feedback block 36 having a variable gain K_{obs}. The output from the block 36, the residual, is combined with the output from the block 32 at a summing point 37 to generate a difference as the input to the block 33.

Thus, the leak rate can be calculated from the observer estimate as:

$${\dot{n}}_{leak} = {\dot{n}}_{Anode\_in} - {\dot{n}}_{consumed} - \hat{\dot{x}} ( t ) \frac{V}{RT}$$

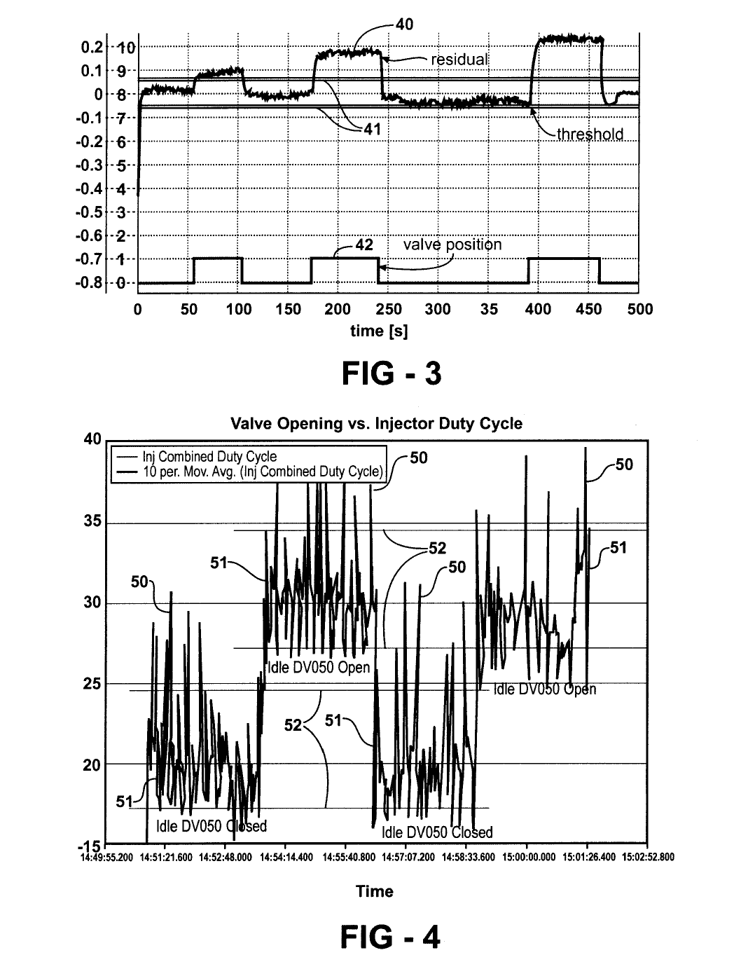

By changing the gain in the block 36, the time constant of the estimate can be changed. Optimal values for gain will be a compromise between fast response time and ruggedness against disturbances to avoid false leak claims based on errors. To detect leaks, it only necessary to check that the residual has exceeded a threshold. FIG. 3 is an example showing an upper plot of the residual 40 along a threshold range indicated by lines 41. To simulate a leak, a valve was opened as represented in a lower plot 42 by a change from “0” (valve closed) to “1” (valve open). During fault free operation, the residual remains close to a zero value within the threshold range. As the graph shows, the residual increases when the valve is open and exceeds the threshold range to indicate the presence of a leak. The differing magnitudes of the increase in the residual shown in FIG. 3 are due to different anode pressures. A higher pressure corresponds to a larger leak and results in a higher residual value.

The model-based diagnostic method according to the present invention detects component failures in the anode subsystem. Such failures include: valve failures (including bleed, drain and vent valves) of the stuck open, stuck closed and leak through valve seat types; injector failures of the stuck open and leak through seat type; leak to atmosphere (hoses, interfaces); and stack crossover. Upon detecting a valve failure, remedial actions include: attempting to unseat a valve by pulsing it on and off; reducing flow through the valve by reducing differential pressure; and close a bleed valve and use a stuck open valve as a bleed valve.

Another way to implement the present invention is to monitor the amount of hydrogen added to the anode relative to the fuel cell power production. This method can be used since hydrogen consumption is directly proportional to the current supplied by the stack. Thus, a diagnostic algorithm includes calculating the required H₂ flow through the injectors based upon the stack current and the state of the valves in the anode subsystem. A flow tolerance band is added for system to system variation and runtime variation in the flow/injector duty cycle. When the amount of hydrogen needed relative to a current output level rises (flow is high), it shows that a valve is stuck open or there is a leak to the atmosphere. The level of flow can identify which valve is stuck open. If the flow is low, an injector is leaking or a valve is stuck closed. An example of this method can be seen in FIG. 4 where the anode drain valve is opening and closing creating a response in the injector duty cycle as indicated by a line 50. The response 50 can be compared with the filtered injector duty cycle signal as indicated by a line 51 and a tolerance band or threshold range indicated by the lines 52.

Hydrogen consumption can be estimated by using the major current density signal by:

$${H}_{2} consmeas ( mol / s ) = \frac{1}{2} \frac{jAn}{F}$$

where:

j=stack current density (amps/cm²)

A=area of stack (cm²)

n=number of cells

F=Faraday's constant=96484.6016 (C/mol)

[Avogadro's number (1/mol)×Elementary change (C)]

Additionally, hydrogen consumption can be calculated by using the moleflow-in through the injector banks and moleflow-out through bleed and vent valves as given by:

H₂conscalc(mol/s)=ΣInjBanks(mol/s)−ΣBleedValves(mol/s)−ΣPressReliefValves(mol/s)

Normalizing the difference between the calculated and measured with the calculated hydrogen consumed, we get

$$Leak = \frac{{H}_{2} conscalc - {H}_{2} Consmeas}{{H}_{2} conscalc}$$

A moving average of the calculated leak can be obtained over three (3) seconds and made as an additional condition to those previously described herein to monitor and determine if the leak persists. If the calculated average leak is greater than a pre-defined threshold for ‘x’ seconds, while simultaneously meeting the criteria described herein then a hydrogen leak could be inferred. Depending on which valves are open and closed at the time of a persistent calculated leak, it would be possible to deduce the specific valve responsible for the leak.

For any approach based on monitoring inputs and outputs it will be important to know if the fuel cell is in a transition state to make adjustments to the models. For instance it may be necessary to track heat output in cases where a fuel cell can have a significant change in its output ratio of heat to electricity. But if in the operating range for a fuel cell the output ratio is constant then the heat output can be ignored when trying to detect a hydrogen leak. To give another example, a drop in fuel cell power output due to water buildup or general voltage degradation should not be confused with a fuel leak.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method of detecting fuel leaks in an anode subsystem of a fuel cell comprising the steps of:
a. measuring an anode pressure related to fuel flow through at least one injector;
b. calculating an anode pressure related to fuel flow through the at least one injector;
c. determining a difference between the measured anode pressure and the calculated anode pressure and comparing the difference with a threshold value; and
d. indicating a fuel leak when the difference exceeds the threshold value.

2. The method according to claim 1 wherein said step b. is performed by using a measured volume, a measured temperature, a calculated fuel input rate and a calculated fuel consumption rate in a model of the anode subsystem.

3. The method according to claim 2 wherein the fuel input rate is calculated from a model of the at least one injector.

4. The method according to claim 2 wherein the fuel consumption rate is calculated from a measurement of the current generated from the fuel cell.

5. The method according to claim 1 wherein said step b. is performed using an observer model of the anode subsystem and the difference is applied to the model as a residual feedback signal.

6. The method according to claim 5 wherein a value of the residual feedback signal is changed by applying a gain.

7. The method according to claim 1 wherein the threshold value is a threshold range and said step d. is performed when the difference exceeds an upper limit of the threshold range.

8. A method of detecting component failures in an anode subsystem of a fuel cell comprising the steps of:
a. calculating a required fuel flow through at least one injector based upon a stack current generated by the fuel call and a state of valves in the anode subsystem;
b. generating a tolerance band;
c. comparing the calculated required fuel flow with the tolerance band; and
d. indicating a component failure when the calculated required fuel flow is above or below the tolerance band.

9. The method according to claim 7 wherein said step d. is performed by indicating the component failure as a valve is stuck open or a leak to the atmosphere when the calculated required fuel flow is above the tolerance band.

10. The method according to claim 7 wherein said step d. is performed by indicating the component failure as the at least one injector is leaking or a valve is stuck closed when the calculated required fuel flow is below the tolerance band.

11. A method of detecting component failures in an anode subsystem of a fuel cell comprising the steps of:
a. calculating a value representing fuel flow through at least one injector in the anode subsystem;
b. generating a tolerance band;
c. comparing the calculated value with the tolerance band; and
d. indicating a component failure when the calculated value is above or below the tolerance band.

12. The method according to claim 11 wherein the value is a duty cycle of the at least one injector.

13. The method according to claim 11 wherein the value is a required fuel flow through at least one injector based upon a stack current generated by the fuel call and a state of valves in the anode subsystem.

14. The method according to claim 11 wherein the value is a residual difference between a measured anode pressure and a calculated anode pressure.

15. The method according to claim 11 wherein the value is a hydrogen consumption equal to a moleflow-in through the at least one injector minus a moleflow-out through any open bleed and vent valves.

16. The method according to claim 11 including calculating a leak value by determining a difference between the calculated value and a measured value of hydrogen consumed and dividing the difference by the calculated value.

17. The method according to claim 16 including calculating a moving average of the leak value over a predetermined time period and comparing the moving average with a threshold value to identify a leak.

18. The method according to claim 17 including identifying a leaking valve by checking which valves are open and closed during the identified leak.
